(19) United States
(12) Patent Application Publication
(10) Pub. No.: US 2004/0080530 A1
(43) Pub. Date: Apr. 29, 2004

(54) Portable wardrobe previewing device

(76) Inventor: Joseph H. Lee, Foothill Ranch, CA (US)

Correspondence Address: GATEWAY, INC., ATTN: SCOTT CHARLES RICHARDSON, 610 GATEWAY DRIVE, MAIL DROP Y-04, NORTH SIOUX CITY, SD, 57049, US

(21) Appl. No.: 10/667,828

(22) Filed: Sep. 22, 2003

Related U.S. Application Data
(63) Continuation-in-part of application No. 09/706,169, filed on Nov. 3, 2000, now Pat. No. 6,661,433.

(51) Int. Cl. G09G 5/00

(52) U.S. Cl. 345/738

(57) ABSTRACT

The present invention provides for a wardrobe previewing system that allows a user to preview how clothing items will look when worn without having to put on the clothing items. The wardrobe previewing system includes a mobile communication device, clothing tags for identifying clothing items, and a means for storing clothing item images. The mobile communication device further includes a camera capable of capturing an image of the clothing tags, a display, and application software for enabling the mobile communication device to display a preview of clothing items on the user. The application software overlays the retrieved clothing item image onto the image of the user or, alternatively, a second person, stored in the memory of the mobile communication device to produce a composite image. The application software then displays the composite image on the display of the mobile communication device to give the user a preview of how the clothing item will look when worn.

### CROSS-REFERENCE TO RELATED APPLICATIONS

The present application is a continuation-in-part of U.S. patent application Ser. No. 09/706,169, filed Nov. 3, 2000, which is herein incorporated by reference in its entirety.

### BACKGROUND OF THE INVENTION

The present invention relates generally to apparatus and methods for purchasing items of clothing, and more specifically to a mobile communication device, such as a mobile telephone, wireless enabled personal digital assistant (mobile communication device), or the like, which allows a user to quickly view the items of clothing as being worn by the user or another person.

When shopping at a clothing store, the typical consumer will often try on many different clothing items before finding one that he or she finds attractive when worn. This process often involves time-consuming trips to the fitting room in which the consumer tries on different items of clothing and stands in front of a mirror to determine if the items of clothing are attractive when worn by the consumer. Consequently, the process of purchasing clothing can be unnecessarily time consuming for the consumer. Moreover, the process requires additional store employees to re-shelve or re-hang unpurchased clothing items left in the fitting room by the consumer. Furthermore, trying on articles of clothing does not allow the consumer to see how they will look with clothing items in the consumer's existing wardrobe. This can be especially troublesome if the user is shopping for clothing items to match or coordinate with items of clothing in his or her existing wardrobe.

Most consumers carry a mobile communication device such as a mobile telephone or a wireless enabled mobile communication device for communication while shopping. Such mobile communication devices typically include a small color display suitable for displaying photographic images. Additionally, many such devices include a small color camera for capturing photographic images remotely.

Consequently, it would be desirable to provide a wardrobe previewing system for a mobile communication device which allows a user to quickly view items of clothing being considered for purchase as they would look if worn by the user or other person, thus eliminating the need to try on the items of clothing.

### SUMMARY OF THE INVENTION

The present invention provides for a wardrobe previewing system for a mobile communication device which allows a user to quickly view the items of clothing being considered for purchase as they would look if worn by the user or other person, thus eliminating the need to try on the items of clothing. The wardrobe previewing system also allows the user to preview how clothing items being considered for purchase at the store will look with clothing items in an existing wardrobe of the user or another person.

In one embodiment of the invention, the wardrobe previewing system includes a mobile communication device such as a mobile telephone, wireless enabled mobile communication device, or the like, with wireless Internet capability, clothing tags for identifying clothing items at the store, and a remote database for storing clothing item images. The mobile communication device preferably includes a camera and/or scanner capable of reading the clothing tags, a display, and application software for enabling the mobile communication device to display a preview of clothing items on an image of the user or, alternatively, another person. In one embodiment, a predefined image of the user is stored by the mobile communication device. Alternatively, an image of the user or other person may be captured by the mobile communication device's camera. Preferably, each clothing manufacturer associates an image of a clothing item for a predefined pose. Accordingly, by having the user capture and store an image of the user or other person in the predefined pose, the overlay of the clothing items will fit well over the image of the user. It is understood in the art that advanced software programming may be utilized to allow for the clothing image to automatically be sized and proportioned to fit over the predefined image of the user or other person. Alternately, the image of the user or other person may be altered to correspond with the clothing image.

At the store, the user scans the clothing tag of a clothing item being considered for purchase with the camera (which functions as a scanner) or a dedicated scanner. The mobile communication device application software then transmits the identification of the scanned clothing item from the mobile communication device to the database via a wireless Internet link. The database retrieves a clothing item image corresponding to the scanned clothing item and transmits the retrieved clothing item image to the mobile communication device. The mobile communication device application software overlays the retrieved clothing item image onto the image of the user or other person stored in the device's memory to produce a composite image. The mobile communication device application software then displays the composite image on the display to give the user a preview of how the clothing item will look when worn by the user or other person.

To preview how a clothing item at the store will look with a clothing item in her existing wardrobe, the user simply scans and saves the clothing images of her various clothing items in her existing wardrobe into the mobile communication device memory. This enables the mobile communication device application software to produce a composite image of the clothing item in the store and the clothing item in the user's existing wardrobe overlaid onto the image of the user.

In another embodiment of the present invention, the image of the clothing item is embedded in the clothing tag itself. In this embodiment, the image of the clothing item is compressed and encoded as a pattern of dots or stripes, such as bar coding, on the clothing tag. The scanner reads the pattern of dots or stripes from the clothing tag. The mobile communication device application software then uses an algorithm that decompresses and decodes the pattern of dots or stripes to construct an image of the clothing item. Alternatively, the clothing item may be provided with a radio frequency tag capable of wireless communication with the mobile communication device. The image of the clothing item is compressed and stored in memory within the radio frequency tag and broadcast to the mobile communication device wherein it is decompressed and displayed as required. In this manner, the need for having the mobile communication device retrieve the clothing item image from a remote database is eliminated.

It is to be understood that both the foregoing general description and the following detailed description are exemplary and explanatory only and are not necessarily restrictive of the invention claimed. The accompanying drawings, which are incorporated in and constitute a part of the specification, illustrate embodiments of the invention and together with the general description, serve to explain the principles of the invention.

### BREIF DESCRIPTION OF THE DRAWINGS

The numerous objects and advantages of the present invention may be better understood by those skilled in the art by reference to the accompanying figures in which:

FIG. 1 is a diagrammatic view illustrating a wardrobe previewing system according to an exemplary embodiment of the invention;

FIG. 2 is a flowchart illustrating an exemplary method for previewing a clothing item using the wardrobe previewing system of the present invention;

FIG. 3 is a flowchart illustrating a method for retrieving images of a clothing item available in different colors according to an exemplary embodiment of the invention;

FIG. 4 is a diagrammatic view illustrating a wardrobe previewing system according to another exemplary embodiment of the invention;

FIG. 5 is a diagrammatic view illustrating a clothing item tag according to an embodiment of the invention; and

FIG. 6 is a diagrammatic view illustrating the display of a mobile communication device according to an embodiment of the invention.

### DETAILED DESCRIPTION

Reference will now be made in detail to the presently preferred embodiment of the invention, an example of which is illustrated in the accompanying drawings.

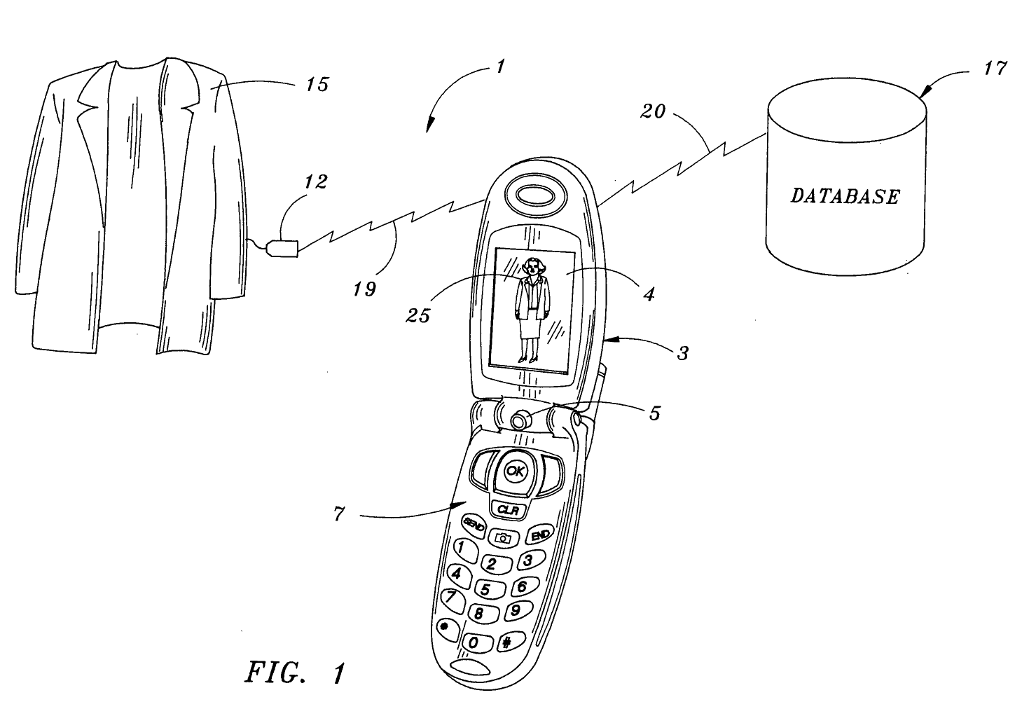

FIG. 1 illustrates a wardrobe previewing system 1 according to an exemplary embodiment of the invention. The system 1 includes a mobile communication device 3 such as a mobile telephone, mobile communication device, or the like, having a memory and wireless Internet capability. The system 1 also includes clothing item tags 12, wherein each tag 12 contains a clothing item identification (ID) identifying the clothing item 15 to which it is associated or attached. For simplicity, only one tag 12 and one clothing item 15 are shown in FIG. 1. However, those of ordinary skill in the art will recognize that the system may employ multiple tags associated with multiple clothing items. The system 1 further includes a remote database 17 for storing clothing item images, preferably in digital form, wherein each clothing item image corresponds to a clothing item ID provided by the tag 12 associated with that clothing item 15.

The mobile communication device 3 includes a camera 5 which, in one embodiment, functions as a scanner capable of reading the clothing item ID's from the tags 12, a display 4, and a keypad assembly 7. In alternative embodiments, the mobile communication device may further include an optical or radio frequency scanner in addition to or in place of the camera 5 for reading the clothing item ID's from the tags 12. The clothing item ID's may be provided by optical indicia printed on the tag (e.g., a bar code) or, alternatively, via a magnetic strip affixed to the tag 12. The camera 5 (or, alternatively, the dedicated scanner) is therefore configured in accordance with the particular clothing item ID used on the tag 12, and may be, for example, a laser scanner adapted to read bar codes, an optical scanner adapted to read two dimensional bar codes, or the like. The mobile communication device 3 further includes application software stored locally in the mobile communication device memory for enabling the mobile communication device 3 to display a preview of clothing items as those clothing items would look as worn by the user or another person (i.e., on the user or other person).

To preview a clothing item using the mobile communication device 3, the user of the mobile communication device 3 first inputs the clothing item ID. For example, in one embodiment, the user captures an image of the clothing tag 12 of the clothing item 15 with the camera 5. Optical recognition software within the mobile communication device application software reads the clothing ID (i.e., barcode) from the captured image of the tag 12. The mobile communication device application software then transmits the read clothing item ID from the mobile communication device 3 to the database 17 via a wireless cellular telephone Internet link 20 (e.g., GPRS, or the like). The database 17 retrieves the clothing item image corresponding to the read clothing item ID, and transmits the retrieved clothing item image to the mobile communication device 3. The mobile communication device application software next overlays the retrieved clothing item image onto an image of the user or other person, which is stored in memory to produce a composite image. The mobile communication device application software then displays the composite image 25 on the display 4 to give the user a preview of the clothing item as worn by the user or other person.

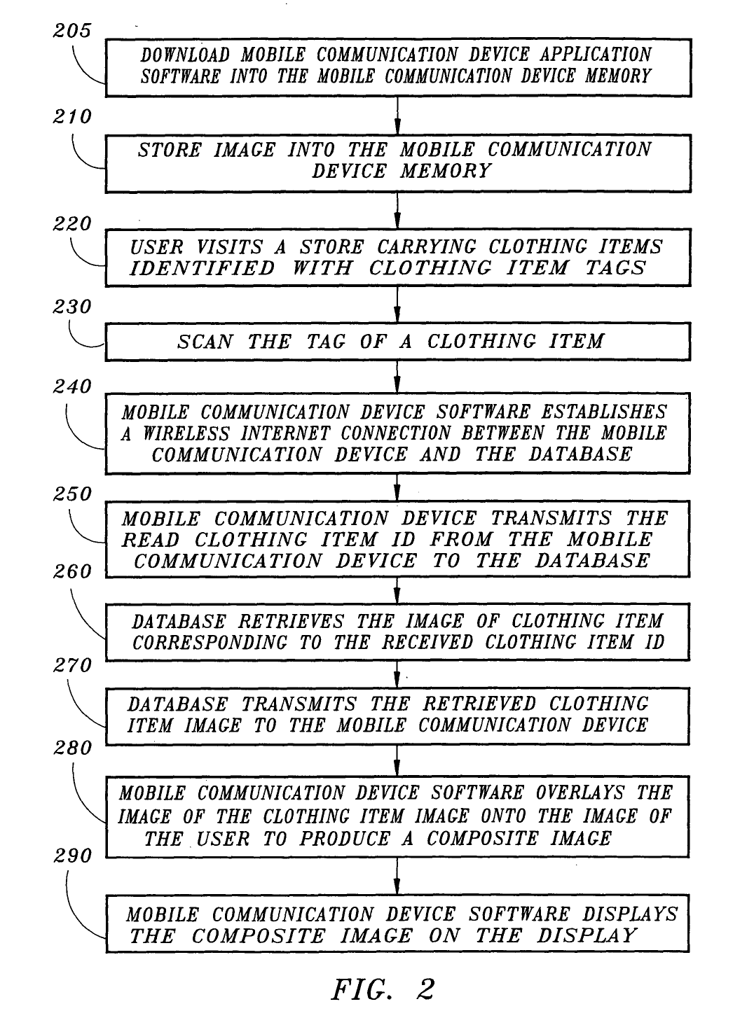

Referring now to FIG. 2, a method 200 for previewing a clothing item using the wardrobe previewing system of the present invention is described. First, in step 205, the user of a mobile communication device 3 may download the mobile communication device application software into the mobile communication device memory for enabling the mobile communication device 3 to preview clothing items on the display 4 (if the mobile communication device 3 is not already provided with the application software). The mobile communication device software can be downloaded into the mobile communication device memory from various sources including, but not limited to, an Internet web site accessible by the mobile communication device, a personal computer system to which the mobile communication device may be interconnected, a mobile telephone service provider, or the like.

In step 210, an image or images of the user and/or images of other persons such as family members (e.g., a spouse, a child, a parent, etc.), friends, shopping companions, or the like, may be stored into the mobile communication device memory. An image of the user or other person, which is preferably in digital form (e.g., MPEG, JPG, GIF, bitmap, or the like), is captured using camera 5, or, alternatively, can be scanned from a photograph or taken with a second digital camera and downloaded to the mobile communication device 3. Preferably, the image depicts the user or other person in a predetermined pose that matches a predetermined pose for the clothing item images in the database 17. In exemplary embodiments, the mobile communication device application software may include an image of a model in the predetermined pose to illustrate the predetermined pose to the user via display 4, the image of the model comprising the image of the other person as described. The image of the user or other person can be stored in various formats including, but not limited to, an MPEG, a JPG, a GIF, a bitmap, or the like. The image may be captured prior to entering the clothing store or while shopping (e.g., when a clothing item is found that is being considered for purchase).

In step 220, the user visits a store or other location selling or providing clothing items that are each identified with a clothing item tag 12. However, it is understood that the tag does not have to be a temporary attachment to the item of clothing. The tag containing the image information may be a permanent tag, such as the interior tag located on the back inside of the collar. Those of ordinary skill in the art will appreciate that a clothing item may include more than one tag for displaying alternate styles, colors, or the like, which may not be present in the store, but may be available to a user such as through ordering, online shopping, or the like. In step 230, the user captures an image of the tag 12 of the clothing item 15 which is being considered for purchase with the camera 5. Optical recognition software within the mobile communication device application software reads the clothing ID (i.e., barcode) from the captured image of the tag 12. The clothing item ID can identify the clothing item 15 by specifying a Uniform Resource Locator (URL) of a file in the database 17 containing the image of the clothing item 15. The clothing item ID can also identify the clothing item 15 by specifying a Universal Product Code (UPC) of the clothing item, which is typically used by cash registers to identify the clothing item.

In step 240, the mobile communication device application software establishes a wireless Internet link between the mobile communication device 3 and the database 17. In step 250, the mobile communication device application software transmits the read clothing item ID 250 from the mobile communication device 3 to the database 17. In step 260, the database 17 retrieves the image of the clothing item corresponding to the received clothing item ID. In step 270, the database 17 transmits the retrieved clothing item image to the mobile communication device 3.

In step 280, the mobile communication device software overlays the retrieved clothing item image onto the image of the user or other person to produce a composite image 25. Preferably, the image of the user or other person was taken in a predetermined pose in step 210 so that the image of the user matches the clothing item image in the composite image 25. In step 290, the mobile communication device application software displays the composite image 25 on the display 4 to show the user how the clothing item will look when worn by the user or other person. This allows the user to quickly preview the clothing item 15 as worn without having to try on the clothing item 15 and stand in front of a mirror.

Preferably, the mobile communication device memory is sufficiently large to store several clothing item images received by the database 17. In this manner, a clothing item image can be stored in the mobile communication device memory for later use without having to be reloaded from the database 17. In embodiments of the invention, the mobile communication device application software may give the user the option of displaying clothing item stored in the mobile communication device memory on the display 4. In addition, the mobile communication device application software may allow the user to select and preview any clothing items already stored in the mobile communication device memory on any images of the user or other persons, using buttons of the keypad assembly 7. This enables the user to quickly preview a previously scanned clothing item without having to rescan or reload the clothing item. In addition, this enables the user to quickly compare two or more previously scanned clothing items on the display 4 to decide which he or she finds most attractive. In one embodiment, the mobile communication device application software enables the mobile communication device 3 to display two or more different composite images on the display 4 at the same time, such as an image of a pair of pants and a matching shirt. Alternatively, the mobile communication device application software may display different composite images side-by-side on the display 4 so that the user can directly compare two or more clothing items, such as two shirts, to decide which one he or she finds most attractive.

An advantage of the present invention is that it allows a user to preview how a clothing item at a store will look with a clothing item in the user's existing wardrobe without having to bring the clothing item to the store. For example, if the user wants to see how a shirt at a store will look with a pair of pants in the user's existing wardrobe, the user simply downloads the clothing image of her pants into the mobile communication device memory before visiting the store. At the store, the user scans the tag 12 of the shirt. The mobile communication device application software can then produce a composite image of the pants and shirt overlaid onto the image of the user to show the user how the shirt will look with the pants in her existing wardrobe.

In exemplary embodiments, the mobile communication device memory is made sufficiently large to store more than one image of the user and/or one or more other persons. For example, the user may store one or more pictures of the user wearing different clothing items in his or her existing wardrobe. Similarly, the user may store images of family members, friends, or the like (optionally wearing different clothing items from their existing wardrobes). The mobile communication device application software allows the user the option of selecting one of the images stored in memory (either of the user or another person) to produce the composite image in step 280. This enables the user to preview the appearance of clothing items being considered for purchase with different clothing items in the user's or other person's existing wardrobe. At a clothing store, the user may then select a clothing item in the user's or other person's existing wardrobe to preview with a clothing item at the store by selecting an image of the user or other person wearing the existing clothing item previously stored in the mobile communication device memory to produce the composite image.

In yet another embodiment, the mobile communication device application software can produce a composite image using two or more clothing item images stored in the mobile communication device memory. In addition, the mobile communication device application software allows the user to select and preview a combination of clothing items stored in the mobile communication device memory using the keypad assembly 7. This allows the user to see how two or more clothing items being considered for purchase whose tags were scanned using camera 5 will look as an outfit or ensemble. For example, suppose the user wishes to see how a shirt and a pair of pants at a store will look together as an outfit. The user can capture an image of the tag 12 using camera 5 and obtain the clothing item ID's of the shirt and pants which are transmitted to the database 17. After the images of the shirt and pants are downloaded into memory from the database 17, the mobile communication device application software overlays the images of the shirt and pants onto the image of the user to produce a composite image that shows a preview of how the shirt and pants will look together as an outfit or ensemble worn by the user (or another person).

In still another embodiment, the present invention gives the user the option of previewing a clothing item in different colors without having to individually scan in the clothing item ID's of different colored clothing items. In this embodiment, the database 17 is capable of determining when clothing items are available in different colors. When the database 17 recognizes that a clothing item is available in different colors, the database 17 may then retrieve images of that clothing item in the different colors. These images may then be transmitted to the mobile communication device 3 in accordance with the present invention.

Furthermore, in an exemplary embodiment in which the tags 12 are permanently affixed to the articles of clothing, the user may observe a clothing item, e.g., a jacket, worn by another person, e.g., a friend, relative, or the like, that the user believes would esthetically match other items of clothing in the user's existing wardrobe. The user may capture an image of the tag 12 on the item of clothing to obtain the clothing item ID for the item. Once the clothing item ID is obtained, the clothing item ID is communicated to the database 17 and an image of the clothing item is downloaded in accordance with the present invention. The user may retrieve a pre-scanned image of the clothing items (e.g., a pair of pants and a shirt) from the user's wardrobe to see how the ensemble of clothing will appear. Alternately, the user may store the downloaded image of the clothing item (e.g., jacket) to combine with images of the existing clothing items which are captured at a later time. Thus, it is understood that the use of the present system is not limited to new clothing that is being displayed in a store. Rather, the present system may be implemented for any article of clothing that provides a tag 12 according to the present system.

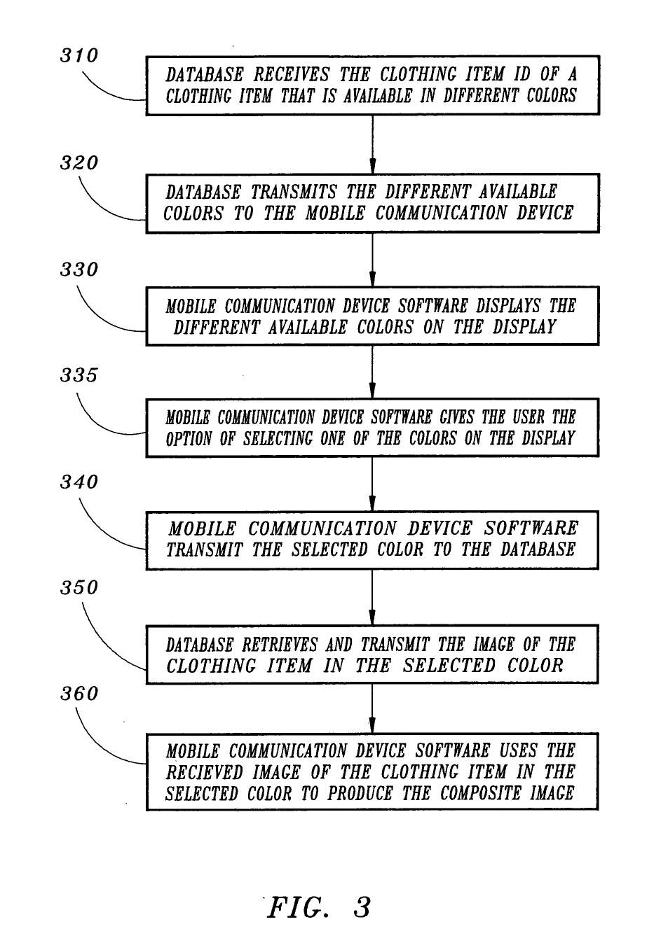

Referring now to FIG. 3, a method 300 for retrieving images of a clothing item in different colors is described. In step 310, the database 17 receives the clothing item ID of a clothing item that is available in different colors from the mobile communication device 3. In step 320, the database 17 recognizes that the clothing item is available in different colors and transmits the different available colors to the mobile communication device 3. In steps 330 and 335, the mobile communication device application software displays the different colors available on the display 4 and gives the user the option of selecting which color to preview. In step 340, the mobile communication device application software transmits the selected color from the mobile communication device 3 to the database 17. In step 350, the database 17 retrieves and transmits the image of the clothing item in the selected color to the mobile communication device 3. In step 360, the mobile communication device application software uses the image of the clothing item in the selected color to produce the composite image. If the user wishes to preview the same clothing item in another color, steps 330 through 360 are repeated. In this manner, the user is allowed to quickly preview the same clothing item in different colors without having to individually scan in the different colors. Alternatively, for clothing items that are available in multiple colors, the software application may provide the user with the ability to take a non-color or “black and white” image of an article of clothing, and then to superimpose a desired color to the image, in order to view the appearance of a particular article of clothing in a particular color.

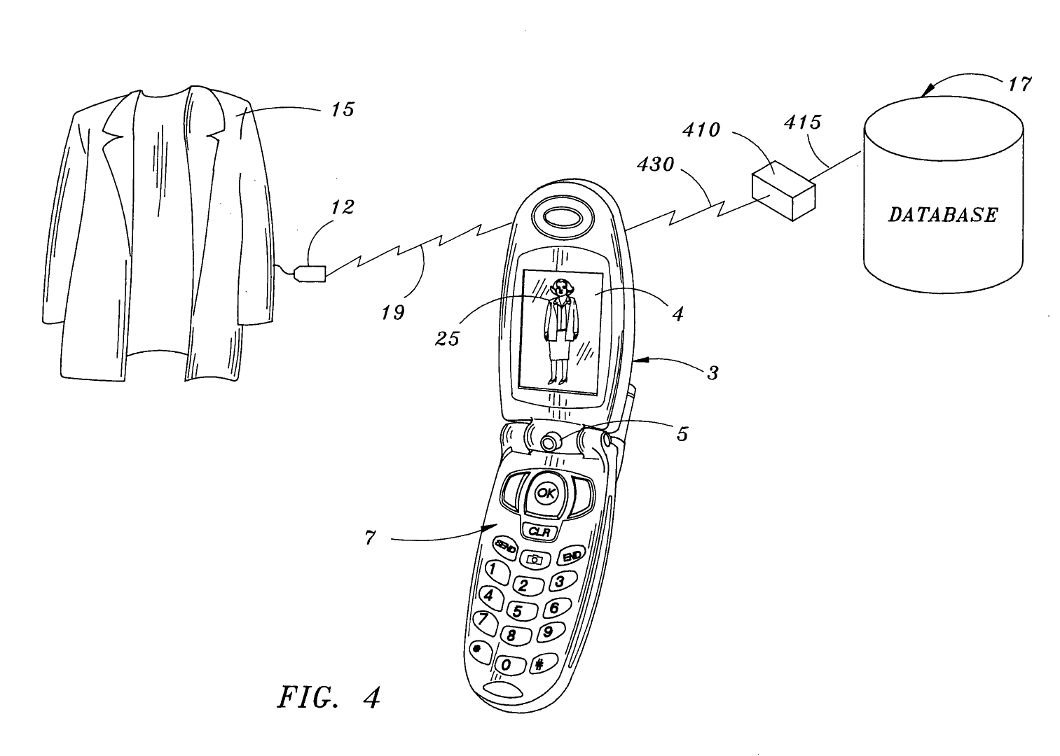

FIG. 4 shows another embodiment of the present invention in which the system 1 includes a remote access port 410 connected to the database 17 via a wireline link 415. The wireline link 415 can include but is not limited to a LAN, a PSTN, or a DSL link. In this embodiment, the mobile communication device 3 includes a short range RF transceiver capable of establishing a wireless link 430 with the access port 410. A Bluetooth link can be used for the wireless link 430. In this embodiment, the mobile communication device 3 communicates with the database 17 through the access port 410 and the wireline link 415. The advantage of this embodiment is that it can achieve a high-speed data connection between the database 17 and the mobile communication device 3 without the use of a wireless telephone service provider.

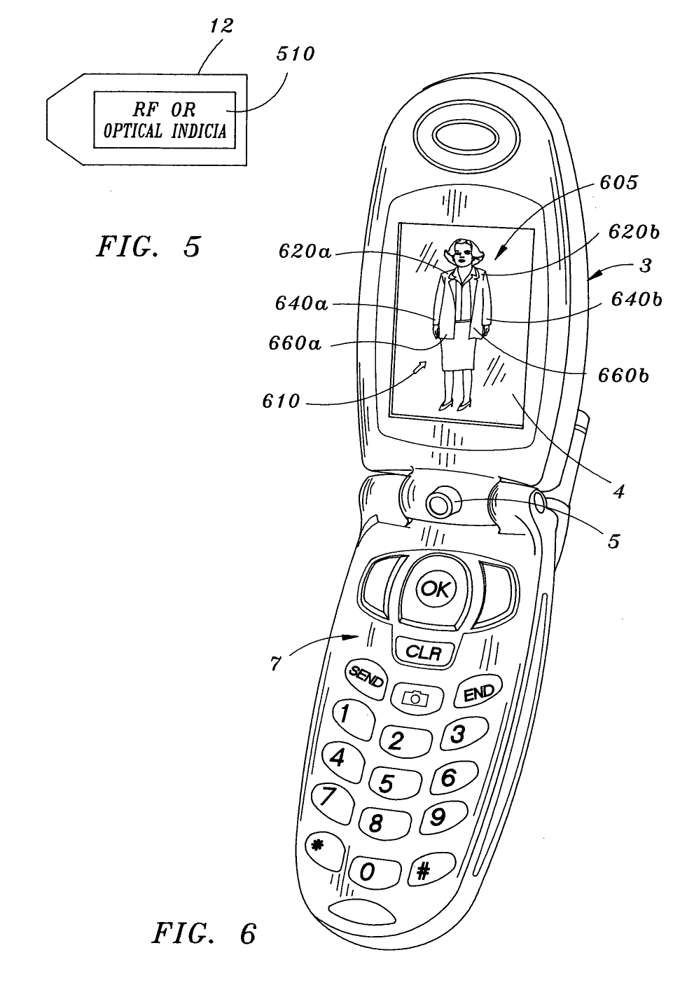

FIG. 5 shows a clothing item tag 12 according to yet another embodiment of the present invention in which the clothing item image is embedded in the tag 12 itself. This eliminates the need to retrieve the clothing item image from the remote database 17. In this embodiment, each clothing item image is encoded and optionally compressed in memory in the tag 12 wherein the tag 12 is an RF tag or RFID tag, or alternatively, as optical indicia, e.g., a pattern of dots, or the actual image of the clothing item, 510 on the tag 12. The mobile communication device reads the embedded clothing item image from the tag 12. For example, wherein the tag 12 is an RF or RFID tag, the clothing item image is transmitted to the mobile communication device. Alternatively, wherein the clothing item image is embedded as optical indicia, the optical indicia are captured by the camera 5 of the mobile communication device 3.

In one embodiment, the mobile communication device application software may employ an algorithm to decompress and decode the clothing item image 510. Various algorithms have been developed for compressing and encoding digital data, such as images and text, as a pattern of dots on printed matter. One such algorithm, developed by INTACTA Technologies, Inc., compresses and encodes digital data as a pattern of dots that can be printed on paper or plastic, and can be read by a standard scanner. In another embodiment, the clothing item image may simply be provided as a picture on the surface of the tag, which is captured using the camera 5 of the mobile communication device 3. There are many advantages for embedding the clothing item image in the tag 12. One advantage is that the mobile communication device 3 does not have to maintain a wireless Internet link with the database 17 to retrieve clothing item images. Another advantage is that capturing or scanning the clothing item image into the mobile communication device 3 from the tag 12 can be faster than retrieving and downloading the clothing item image from a database 17. Furthermore, a database 17 need not be provided or maintained. Another approach would be through the use of magnetic media in the clothing tag 12 such that an electronic strip reader could be used to create an image of the clothing item. Other approaches, such as bar codes, are contemplated within the scope of the present invention.

FIG. 6 shows the mobile communication device 3 according to still another embodiment of the present invention in which the mobile communication device application software adjusts the position and proportions of the clothing item image to better fit the image of the user 605. In this embodiment, the mobile communication device application software displays the image of the user 605 with a pointer 610 on the display 4. The mobile communication device application software enables the user to move the pointer 610 within the image 605 using the selected keys of keypad assembly 7, an input device, such as an input pen (not shown), or the like. The mobile communication device application software also enables the user to mark off different body parts on the image 605 using the pointer 610 and keypad assembly 7, or alternatively the input device, or the like.

In FIG. 6, for example, points 620a and 620b mark the position of the user's right and left shoulder, respectively, points 640a and 640b mark the position of the user's left and right wrist, respectively, and points 660a and 660b mark the position of the left and right side of the user's waist, respectively. When the user has finished marking off the image 605, the mobile communication device application software stores the coordinates of the different body parts into the mobile communication device memory. The coordinates of the different body parts can later be used to indicate the proportions of the user's body on the image 605. When the mobile communication device 3 receives a clothing item image from the database 17, or from the clothing tag 12, the mobile communication device application software adjusts the position and proportions of the clothing item image according to the coordinates of the different body parts. For example, the mobile communication device application software can use the distance between the user's right shoulder and right wrist, points 620a and 640a, respectively, to adjust the sleeve length of a shirt image. Furthermore, the mobile communication device application software can use the distance between the left and right side of the user's waist, points 660a and 660b, respectively, to adjust the width of the shirt image. Because the clothing item image is in digital form, the mobile communication device application software can employ well known digital image processing techniques to adjust the proportions of the clothing item image.

The examples in FIG. 6 are used for illustrative purposes and are not intended to limit the different body parts that can be marked off according to this embodiment of the present invention. In addition, the proportions of the clothing item image do not have to be adjusted by the mobile communication device application software. Instead, a processor at the database 17 can adjust the proportions of the clothing item image before transmitting the image to the mobile communication device 3. This requires that the mobile communication device 3 transmit the body position coordinates to the database 17. The advantage of this approach is that it reduces the processing requirements of the mobile communication device 3.

The mobile communication device 3, which in a preferred embodiment comprises a mobile telephone, may further include components for providing wireless communication of voice and/or data information with external sources such as a base station, a cellular communication system tower, a second mobile communication device, or the like. For example, the mobile communication device 200 may comprise a processing assembly, memory, a transmitter/receiver assembly or transceiver, an antenna, a power source such as a battery, and the like. Additionally, it is contemplated that the mobile communication device 3 may provide functions other than telephony. For example, the mobile communication device 3 may provide functions common to hand held computers or personal digital assistants. In such embodiments, the mobile communication device may further include a suitable processing system, extended memory, a touch screen overlaying display 214 for tactile input of data, or the like.

Those skilled in the art will appreciate that various modifications may be made to the exemplary embodiments described herein without departing from the spirit and scope of the invention. For example, even though the present invention was described using a mobile communication device, one skilled in the art will appreciate that other portable devices can be used, such as a palmtop computer, a combination mobile telephone/palmtop computer, or the like without departing from the scope and intent of the present invention.

It is believed that the portable wardrobe previewing system of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A method for previewing the appearance of clothing as worn using a mobile communication device having a display, wherein the clothing item has an associated clothing item ID, comprising:
receiving the clothing item ID;
accessing a clothing item image based upon the clothing item ID;
overlaying the retrieved clothing item image onto an image of at least one of a user of the mobile communication device and a second person to produce a composite image; and
displaying the composite image on the display.

2. The method of claim 1, wherein the clothing item ID is a code capable of being processed by an application running on said mobile communication device to render the clothing item image.

3. The method of claim 1, wherein the step of receiving the clothing item ID comprises capturing an image of a tag associated with the clothing item, the tag providing the clothing item ID, and reading the clothing item ID from the capture image of the tag.

4. The method of claim 1, further comprising the steps of:
receiving a second clothing item ID associated with a second clothing item;
accessing a second clothing item image based on the second clothing item ID;
overlaying the accessed second clothing item image onto the image of at least one of a user of the mobile communication device and a second person to produce a second composite image; and
simultaneously displaying the first and the second composite images on the display.

5. The method of claim 4, wherein the step of receiving the clothing item ID comprises capturing an image of a tag associated with the clothing item, the tag providing the clothing item ID, and reading the clothing item ID from the captured image of the tag, and wherein the step of receiving the second clothing item ID comprises capturing an image of a second tag associated with the second clothing item, the second tag providing the second clothing item ID, and reading the second clothing item ID from the captured image of the second tag

6. The method of claim 1, further comprising the steps of:
receiving a second clothing item ID associated with a second clothing item;
accessing a second clothing item image based on the second clothing item ID;
overlaying the accessed first and second clothing item images onto the image of at least one of a user of the mobile communication device and a second person to produce a second composite image; and
displaying the second composite image on the display.

7. The method of claim 6, wherein the step of receiving the clothing item ID comprises capturing an image of a tag associated with the clothing item, the tag providing the clothing item ID, and reading the clothing item ID from the captured image of the tag, and wherein the step of receiving the second clothing item ID comprises capturing an image of a second tag associated with the second clothing item, the second tag providing the second clothing item ID, and reading the second clothing item ID from the captured image of the second tag

8. The method of claim 1, wherein more than one image of at least one of the user and the second person is stored by the mobile communication device and the method further comprises the steps of:
prompting the user to select one of the more than one image of the user or the second person stored by the mobile communication device; and
overlaying the retrieved clothing item image onto the selected image of the user or second person to produce the composite image.

9. The method of claim 1, wherein the step of retrieving a clothing item image comprises the steps of:
establishing a wireless link between the mobile communication device and a database;
transmitting the clothing ID item from the mobile communication device to the database;
retrieving the clothing item image from the database based on the transmitted clothing item ID; and
transmitting the accessed clothing item image from the database to the mobile communication device.

10. The method of claim 9, wherein the wireless link is a wireless Internet link.

11. The method of claim 10, wherein the clothing item ID specifies a URL of a file in the database containing the clothing item image.

12. The method of claim 9, further comprising the steps of:
determining if a clothing item associated with the clothing item ID is available in at least two different colors; and
if the clothing item is available in at least two different colors, performing the steps of:
displaying the different colors in which the clothing item is available on the display;
prompting the user to select one of the at least two different colors on the display;
transmitting the color selection from the mobile communication device to the database;
retrieving a clothing item image in the selected color from the database;
transmitting the clothing item image in the selected color from the database to the mobile communication device; and
overlaying the retrieved clothing item image in the selected color onto the image of the user or second person to produce the composite image.

13. The method of claim 1, wherein the step of retrieving a clothing item image comprises the steps of:
establishing a link between the mobile communication device and an access port;
establishing a link between the access port and a database;
transmitting the clothing item ID from the mobile communication device to the database through the access port;
retrieving a clothing item image from the database based on the transmitted clothing item ID; and
transmitting the retrieved clothing item image from the database to the mobile communication device through the access port.

14. The method of claim 1, further comprising the steps of:
displaying the image of the user or second person on the display;
enabling the user to mark off different body parts on the image of the user or second person;
storing coordinates of the body parts marked off by the user; and
adjusting proportions of the accessed clothing item image according to the coordinates of the body parts marked off by the user.

15. A method for previewing the appearance of a clothing item as worn using a mobile communication device having a display, wherein the clothing item has an associated tag providing an image of the clothing item, comprising:
accessing the clothing item image from the tag;
overlaying the clothing item image onto a stored image of at least one of a user of the mobile communication device and a second person to produce a composite image; and
displaying the composite image on the display.

16. The method of claim 15, wherein the mobile communication device further includes a camera, and wherein the clothing item image is provided in the tag as optical indicia readable by the camera.

17. The method of claim 15, wherein the tag comprises an RF tag having memory and the clothing item image is stored in the memory of the RF tag.

16. The method of claim 15, further comprising the steps of:
accessing a second clothing item image from a second tag associated with a second clothing item;
overlaying the second clothing item image onto the image of at least one of the user and a second person to produce a second composite image; and
simultaneously displaying the first and the second composite images on the display.

17. The method of claim 15, further comprising the steps of:
accessing a second clothing item image from a second tag associated with a second clothing item;
overlaying the first and second clothing item images onto the image of the user or second person to produce a second composite image; and
displaying the second composite image on the display

18. A mobile communication device, comprising:
a display for displaying an image to a user of the mobile communication device; and
a memory for storing an image of at least one of the user of the mobile communication device and a second person;
wherein the mobile communication device accesses a clothing item image based upon a received clothing item ID associated with a clothing item to be previewed and overlays the clothing item image onto the image of the user or second person to produce a composite image for display by the display.

19. The mobile communication device of claim 18, wherein the mobile communication device further includes a camera for capturing an image of the tag, the clothing item ID being discerned from the captured image.

20. The mobile communication device of claim 18, wherein the clothing item ID is provided via an RF tag associated with the clothing item, the RF tag having memory and the clothing item ID being stored in the memory.

21. A mobile communication device, comprising:
a display for displaying an image to a user of the mobile communication device; and
a memory for storing an image of at least one of the user of the mobile communication device and a second person;
wherein the mobile communication device accesses a clothing item image from a tag associated with a clothing item to be previewed and overlays the clothing item image onto the image of the user or second person to produce a composite image for display by the display.

22. The mobile communication device of claim 21, wherein the mobile communication device further includes a camera, and wherein the clothing item image is provided on a tag associated with the clothing item as optical indicia readable by the camera.

23. The mobile communication device of claim 21, wherein the clothing item image is provided via an RF tag associated with the clothing item, the RF tag having memory and the clothing item image being stored in the memory.

24. A portable wardrobe previewing system, comprising:
a mobile communication device having a display,
a tag associated with a clothing item to be previewed, the tag providing a clothing item image;
wherein the mobile communication device accesses the clothing item image from the tag and overlays the clothing item image onto an image of at least one of a user of the mobile communication device and a second person to produce a composite image, the composite image being displayed on the display.

25. The portable wardrobe previewing system of claim 24, wherein the mobile communication device further includes a camera, and wherein the clothing item image is provided on the tag associated with the clothing item as optical indicia readable by the camera.

26. The portable wardrobe previewing system of claim 24, wherein the clothing item image is provided via an RF tag associated with the clothing item, the RF tag having memory and the clothing item image being stored in the memory.

27. A portable wardrobe previewing system, comprising:
a mobile communication device having a display,
a tag associated with a clothing item, the tag providing a clothing item ID for the clothing item,
wherein the mobile communication device receives the clothing item ID from the tag, the clothing item ID being used for accessing a clothing item image whereupon the clothing item image is overlaid onto an image of at least one of a user of the motile communication device and a second person to produce a composite image for being displayed on the display.

28. The portable wardrobe previewing system of claim 27, wherein the mobile communication device further includes a camera for capturing an image of the tag, the clothing item ID being discerned from the captured image.

29. The portable wardrobe previewing system of claim 27, wherein the tag comprises an RF tag having memory, the clothing item ID being stored in the memory.
